(19) United States
(12) Patent Application Publication
(10) Pub. No.: US 2008/0093168 A1
(43) Pub. Date: Apr. 24, 2008

(54) Flow Rate Controller For a Closed Fluid Circulating System

(75) Inventor: Ronald William Arthur, Waurn Ponds (AU)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(73) Assignee: FALLSAFE TECHNOLOGY PTY LTD, Waurn Ponds, Victoria (AU)

(21) Appl. No.: 11/661,745

(22) PCT Filed: Sep. 1, 2005
(86) PCT No.: PCT/AU05/01329

§ 371 Date: Jun. 29, 2007

(30) Foreign Application Priority Data
Sep. 1, 2004 (AU) 2004904998

(51) Int. Cl. A62B 1/12; F16D 57/06; F15B 13/042

(52) U.S. Cl. 182/51

(57) ABSTRACT

A flow rate controller (40) for a closed fluid circulating system, the controller including an orifice (41) between the upstream high pressure fluid (42) and the downstream low pressure fluid in the system, a valve member (44) biased to partially close the orifice (41) and cooperating with a piston member (47) having one end exposed to low pressure fluid (51)downstream of the orifice (41) and an opposed end (52) exposed to upstream high pressure fluid via a bypass passage (53), whereby as upstream high fluid pressure (42) increases, the piston member (47) acts to move the valve member (44) further into the orifice (41) to reduce the fluid flow through the system. The flow rate controller (40) is used to control a descent device to enable people or loads to descend from elevated locations in emergency situations.

### TECHNICAL FIELD

This invention relates to a flow rate controller for a closed fluid circulating system, and more particularly, but not exclusively, a controller for incorporation in a descent apparatus to enable persons or loads to descend from elevated locations, such as, from high rise buildings in emergency situations; from cliff faces in rescue operations; or for use by defence personnel or rescue personnel when descending from helicopters; although the apparatus is applicable to any situation where a person, or for that matter equipment or other loads, is to be lowered at a controlled rate from an elevated location. For the purposes of this specification reference will primarily be made to the use of the controller, and its incorporation, in a descent apparatus.

### BACKGROUND ART

Such a descent apparatus in disclosed in the specification for our International Patent Application No. PCT/AU2003/000852 (Publication No. WO 2004/004836 A1. In that apparatus a cable or rope is anchored at the elevated location and wound around a pulley apparatus connected to the person or load and from which the cable or rope unwinds from at a controlled rate as the person or load descends from the elevated location.

Although descent apparatus utilising cables or ropes are known, but not necessarily commonly known, such require some degree of training and experience in controlling the rate of descent, and thus are not suitable for escape or rescue operations where, not only due to the persons likely to be inexperienced, but are also in a severely stressful situation, involving a degree of panic and fear generated by the danger to which they are subjected, in the case, for example, of a fire in a high rise building, coupled with the necessity to escape from a particularly high location which in itself presents its own fears. In addition, in cases where persons concerned are injured or even unconscious or semi-conscious, and therefore not in a condition to control the rate of descent, then they are totally reliant on the apparatus to lower them to the ground and also control their rate of descent.

Other apparatus which has been proposed includes the use of flexible chutes, but such apparatus has its limitations with regard to the height over which it can operate and other difficulties particularly with escape from high rise buildings where fires at lower levels within the building not only involve the existence of flames, but also the creation of unstable conditions adjacent the faces of the building as a result of updraughts of hot air.

One other descent apparatus or system is disclosed in International patent publication no. W089/00063 in connection with which the inventor associated with this present application was a coinventor, and involved the use of a cable or rope of twisted configuration and surrounded by a lowering device having an inner rotatable means engaging the cable or rope to follow the twist therein and thereby rotate about the cable or rope as it descends down the cable or rope. The inner rotatable means was rotatably supported within an outer housing having means to support a load, e. g. a person, therefrom, and means were provided to control the speed of rotation of the inner rotatable means and as a consequence the rate of descent of the lowering device down the cable or rope. With such an apparatus, although the inner rotatable means was free to rotate about the cable or rope as it descended, the weight of the load or person suspended from the outer housing held the outer housing against uncontrolled rotation about the cable or rope and thus the load or person being lowered maintained a fixed position relative to, and supported by, the cable or rope during the descent down the cable or rope.

In this previous patent publication a number mechanisms for controlling the speed or rotation of the inner rotatable means was disclosed, including the use of a closed circuit gear pump driven by the inner rotatable means and forming part of a hydraulic circuit containing a constriction to control the speed of the pump and therefore the speed of rotation of the inner rotatable means, and as a consequence the speed of descent.

Although this apparatus had been trialed and tested it has never been commercialised, and could not be said to be commonly known in the art of descent apparatus, devices or systems.

Although in principle the device achieved the objective required its application was complicated by the requirement for a special twisted cable or rope and the necessity to anchor the lower end of the cable or rope to the ground surface below.

In the specification of International Patent Publication No. WO 2004/004836 A1 there is disclosed a closed circuit fluid to gear pump for controlling the rate of descent of a descent apparatus and which incorporates a speed control mechanism which requires manual adjustment to control the speed of descent of the apparatus and thus the speed of descent of the person or load, particularly in order to take into account the weight of the person or load. However, in the stressful situations that may exist, adjustment manually may not be practical or even possible.

It is these issues that have brought about the present invention.

### DISCLOSURE OF THE INVENTION

The invention therefore envisages a flow rate controller for a closed fluid circulating system, said controller including an orifice between upstream high pressure fluid and downstream low pressure fluid in said system, a valve member biased to partially close said orifice and cooperating with a piston member having one end exposed to low pressure fluid downstream of said orifice and an opposite end exposed to upstream high pressure fluid via a by-pass passage, whereby, as upstream high fluid pressure increases said piston member acts to move said valve member further into said orifice to reduce the fluid flow through the system.

Preferably, the position of the valve member relative to the orifice is externally adjustable.

The bypass passage includes a first jet to control flow to the piston member and a second jet to control return to a low pressure reservoir.

The valve member is preferably screw threadedly attached to the piston member whereby axial rotation of the valve member axially displaces the valve member relative to the piston member.

Preferably the closed fluid circulating system includes a gear pump.

Preferably the gear pump is incorporated in a descent apparatus of the type disclosed in International Patent Publication No. WO 2004/004836 A1.

### BRIEF DESCRIPTION OF THE DRAWINGS

Embodiments of the invention, as incorporated in a descent apparatus, including a closed circuit fluid gear pump, will now be described with reference to the accompanying drawings, in which;

FIG. 1 is a schematic perspective view of the descent apparatus of this preferred embodiment of the invention,

FIG. 2 is a cross-sectional view taken along line 2-2 of FIG. 1,

FIG. 3 is a cross-sectional view taken along line 3-3 of FIG. 2,

FIG. 4 is a cross-sectional view taken along line 4-4 of FIG. 3,

FIG. 5 is a cross-sectional view taken along line 5-5 of FIG. 3, and

FIG. 6 is a schematic view of the flow rate controller of this preferred embodiment of the invention; and

FIG. 7 is a cross sectional view similar to FIG. 3 but of a modified version of descent apparatus.

### DESCRIPTION OF THE EMBODIMENTS

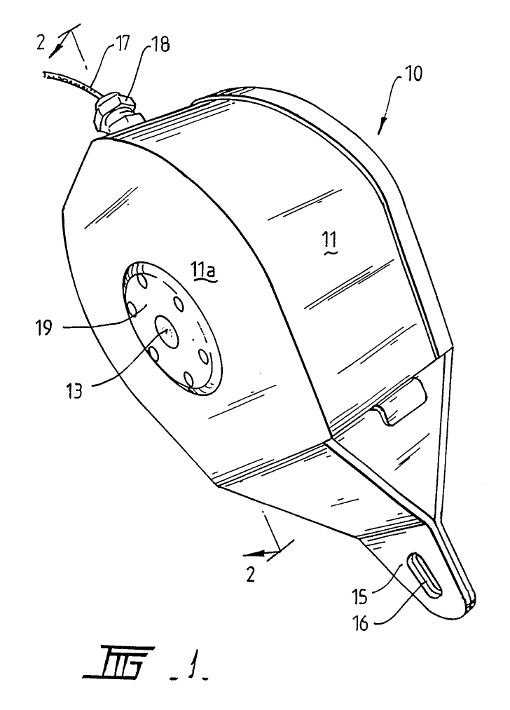

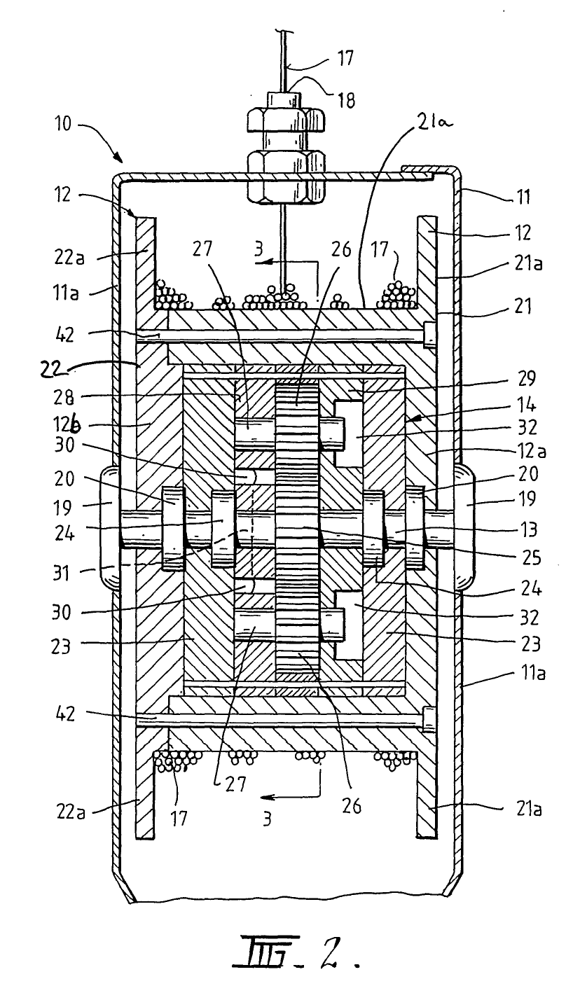

With reference to FIGS. 1 and 2 of the drawings, the descent apparatus of this preferred embodiment of the invention, and generally indicated as 10, comprises an outer housing 11 within which is rotatably mounted an inner pulley 12 via an axle shaft 13 and between which a closed circuit gear pump transmission assembly, generally indicated as 14, is incorporated to control the rotation of the inner pulley around the axle shaft 13. The outer housing has a coupling lug 15 with a hole 16 therethrough by which to suspend a load, such as a person, via a harness (not shown) and a detachable coupling (also not shown).

A cable or rope 17 is wound around the inner pulley 12 which acts as a spool. The cable 17 is of a total length sufficient to extend from an elevated fixed position at one end of the cable or rope down to a lower level, such as a ground level, when the cable or rope is unwound or at least partially unwound from the pulley. The cable or rope 17 exits from the outer housing through an exit port 18 and its end is fixed to a structure at the elevated location, and when the cable or rope is fully wound onto the pulley the apparatus is immediately adjacent the point of fixation at the elevated location. As the apparatus, with the load or person suspended therefrom, descends/drops/falls from the elevated location the cable or rope unwinds from the pulley.

Gear pumps usually operate with two meshing gears located in a chamber such that the gear tips just touch the internal surface of the chamber. The gear spindles pass through end plates that are located firmly against the end surfaces of the gears. In each end plate there is a small oil entry point near where the meshed gear teeth just start to separate. As the meshing gears part a cavity is created and oil is drawn in from the oil entry point located in the end plates. The oil is then carried around in the cavities between the gear teeth and the chambers. The gap between the gear teeth tips and the chamber is very small. In each end plate there is a small oil exit point near where the gear teeth just start to merge. As the gears merge, a cavity full of oil is reduced in size and oil is forced out each oil exit point located in the end plates. Oil pressure is increased in the pump when the oil is transported by the gears from the low pressure entry point around to the high pressure outlet point.

The efficiency of gear pumps is dependent on oil leakage. The most significant oil leakage is caused by the end plates flexing outwardly caused by the extreme high pressure of the oil in the cavities between the gear teeth and the enclosing chamber. As the end plates flex an oil path short circuit is created between the low pressure oil entry point and the high pressure oil exit point. This substantially increases the oil flow and reduces the efficiency of the pump. Oil leakage can also occur between the tips of the gears and the enclosing chamber. This leakage can be reduced when the gears in the enclosing chamber are made accurately with small gaps at the tips of the teeth. Oil leakage can also occur between the meshing teeth but this can be kept to a minimum by providing meshing teeth that are highly toleranced.

The rate of descent is controlled by the closed circuit gear pump transmission 14 which will now be described. In the gear pump transmission 14 illustrated herein the axle shaft 13 is fixed at either end to sidewalls 11a of the outer housing 11 by fixing means 19, whilst roller bearings 20 support side walls 12a and 12b of the inner pulley 12 about the axle shaft 13 to allow the pulley to rotate about the shaft. The pulley consists of a cupshaped member 21 including a cylindrical hollow boss 21a that is integrally formed with a plate that defines one of the sidewalls 12a. Bolts 42 interconnect the cup-shaped member 21 to a closure member 22 which includes the other sidewall 12b. The exterior of the boss 21a defines a spool which with the radial flanges 21a and 22a of the side walls 12a and 12b define a space to retain the cable or rope 17 when wound onto the spool of the pulley. The cup-shaped member 21 together with the closure member 22 also define an inner cavity which receives the closed circuit pump transmission 14.

The outer diameter of the spool of the pulley 12, the gap between the flanges 21a and 22a together with the cross section of the wire or cable define the capacity for the spool to support a long length of wire or cable. As the cable or wire unwinds, the effective diameter of the spool reduces which varies the effective torque on the pulley. To reduce this variation in torque the change in diameter is kept to a minimum which means that the spacing of the flanges 21a and 22a is increased to accommodate the length of cable or wire. In other words the difference between the effective diameter of the spool when wound-up and unwound is kept to a minimum.

The closed circuit gear pump transmission has circular end walls 23 with roller bearings 24 allowing free rotation of the gear pump assembly about the axle shaft 13.

With reference to FIGS. 2 to 5 of the drawings, the gear pump transmission comprises a central sun gear 25 fixed to the axle shaft 13, and in driving engagement with two diametrically opposed planet gears 26 which in turn are mounted on pinions 27 retained at either sides of the planet gear in a pair of mounting plates 28 and 29 between which the gear train is sandwiched. As a consequence the outer housing 11, the axle shaft 13 and the sun gear 25 are all fixed together and remain stationary in space, whilst the pulley 12, the end walls 23, the mounting plates 28 and 29, and the planet gears 26 rotate in unison about the axle shaft 13 and the sun gear 25 and within the outer housing 11.

A series of orifices 30 and cavities 32 are provided through the mounting plates 28 and 29 with an interconnecting channel 31, and which all allow for hydraulic fluid to be pumped by the gear pump through a closed circuit within the gear pump assembly.

As the pulley rotates and the cable or rope unwinds therefrom, the pulley, the end walls 23, the mounting plates 28 and 29 and the planet gears 26 rotate about the sun gear 25 whereby the gear train acts as the gear pump pumping hydraulic fluid through a closed circuit, the path of which includes the spaces between the gears, the orifices 30, the channel 31 and cavities 32.

The gear pump in itself, having to pump fluid through a closed circuit, offers some resistance to rotation of the planet gears 26, and therefore the pulley 12, about the sun gear 25, the axle shaft 13 and within the housing 11, and therefore controls to some degree the rate of descent of the apparatus. However, in order to achieve control over the speed of descent, the apparatus of International Patent Publication No. WO 2004/004836 A1 included a speed control mechanism 33 which consisted of a conical valve member 34 cooperating with a mating seat 35 in the end of one of the orifices 30 through the mounting plate 29, thus forming a constriction. The valve member was carried by a grub screw 36 which can adjust the position of the valve member and set the amount of constriction and therefore the rate of flow of hydraulic fluid through the closed circuit, and when necessary the position of the valve member and the size of the constriction can be adjusted via the grub screw to vary the controlled speed of descent.

Descent apparatus of the kind described above, when used to suspend humans averagely weighing between 50 kg and 160 kg, at a descent speed of approximately 1.5 metres per second creates enormous internal pressures in the gear pump with pressures often exceeding 3,000 psi.

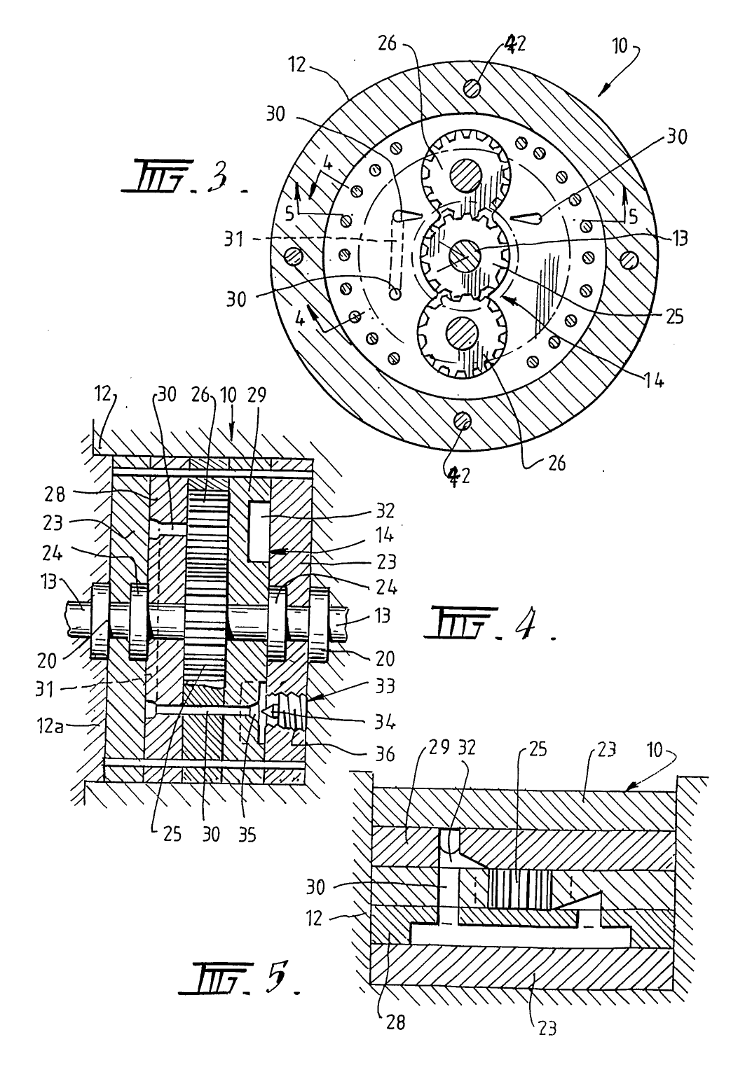

The efficiency of such apparatus and in particular the necessity for strength and highly toleranced components has much to do with the internal pressures and these can be reduced by use of efficient gear systems. When three gears of a kind shown in FIG. 3 mesh together, they in effect constitute four mini pumps. The number of oil entry points becomes two and the number of oil exit points becomes two. Thus, the use of a plurality of planet gears around a sun gear increases the effective number of mini pumps and thus reduces the overall pressure of the system. The lower the oil pressures the less likely there is of oil leakage.

A further means of reducing the overall hydraulic pressure is to increase the diameter of the sun gear and in the embodiment shown in FIG. 7, a sun gear 125 of double the diameter to the two planet gears 26 is provided. By doubling the diameter of the sun gear 125, the equivalent number of mini pumps is increased from four to eight and the volume of oil pumped doubles thus reducing the oil pressure by half. FIG. 7 also illustrates the use of eighteen equally spaced bolts 110 or cap head screws that firmly hold the end walls together with the gears sandwiched therebetween.

In the embodiment shown in FIG. 7, the reduction in internal oil pressures allows the use of a considerably smaller volume of oil and reduces the overall size of the apparatus which in this embodiment comprises a substantially cylindrical unit that has an external diameter of about 200 mm and cylindrical length of about 100 mm. This unit provides a capacity to store about 100 metres of steel cable of 4 mm diameter. The reduction in spool diameter from a maximum fully wound situation to a fully unwound situation is about 40% and the unit operates about 20 cc of oil, allowing a human weighing between 50 kg and 160 kg to descend at a substantially constant speed of about 1.5 metres per second.

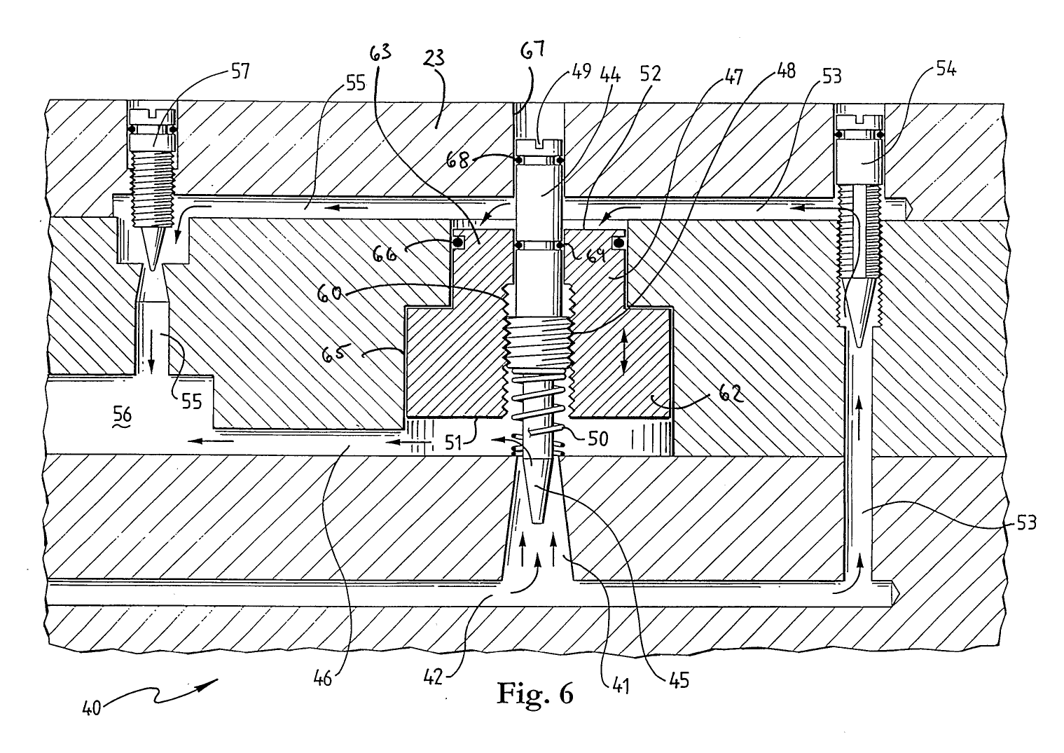

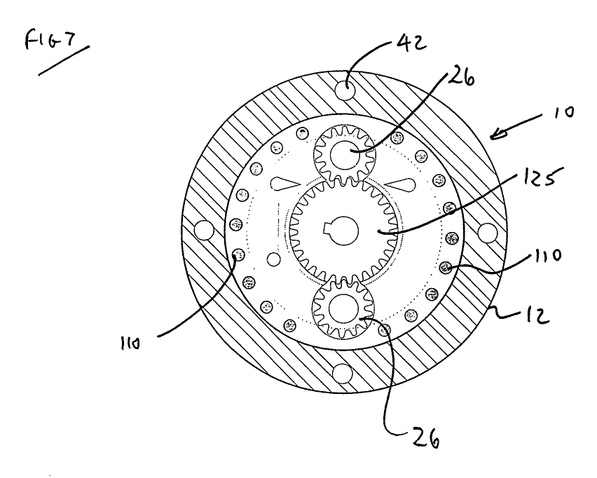

In accordance with the preferred embodiment of the invention, the speed control mechanism 33 of FIG. 4, is replaced with the speed control mechanism 40 schematically illustrated in FIG. 6 of the drawings, which allows for automatic adjustment of fluid flow through the closed circuit fluid gear pump and thus automatically controls the rate of descent of the apparatus and the person or load attached thereto and depending on the weight of the person or load.

A main orifice 41 of tapering cross section is provided which communicates at one end with upstream high pressure fluid 42 in the closed circuit gear pump and at the other end with downstream low pressure fluid in the pump. An elongate valve member 44 is axially aligned with the orifice and is adjustable whereby a conical end 45 thereof is moveable into the orifice 41 to control fluid flow through a passage 46 to a reservoir 56 for the downstream low pressure fluid.

The valve member 44 has an external thread 48 that is screwed into a threaded bore 60 centrally positioned within a piston member 47 having a stepped outer profile 61 to define a head 62 having a lower face 51 and a tail 63 of reduced cross section. The piston member 47 is co-axially located within a stepped bore 65 and sealed therein with an oil ring 66. The valve member 47 extends through the piston member 47 and through a bore 67 in the end wall 23 of the gear pump and is sealed to the bores 67 and 60 by 'O rings 68 and 69. The outer end of the valve member 47 has a slot 49 that can be turned by a screw driver from the exterior of the housing 11 to adjust the relative position of the valve member to the piston member 47 and the conical end 45 to the orifice 41. A coil spring 50 urges the piston member upwardly to the position shown in FIG. 6.

The end 51 of the head of the piston member adjacent the orifice 41 is exposed to low pressure fluid downstream of the valve member 44, whilst its other end 52 is also exposed to high pressure fluid via a by-pass passage 53 incorporating an adjustable flow jet 54. The chamber for the piston member communicates with a bleed transfer passage 55 leading to the low pressure reservoir 56.

By use of the externally turnable slot 49, the position of the valve member 44 is preset to a neutral position to allow a preset fluid flow through the fluid circulating system of the gear pump. The flow jet 54 in the by-pass passage 53, and the bleed jet 57 in the transfer passage 55, are also preset to allow a preset fluid flow through the bleed line in accordance with the gear pump speed suitable for the average weight of a person or load. The bleed jet 57 ensures sufficient pressure on the piston member 47 but also ensures bleed back to the low pressure reservoir to complete the bypass circuit. However, with persons or loads of greater weight, the speed of the gear pump would be greater as would the fluid pressure within the system, and the higher fluid pressure through the by-pass passage 53 acts on the end 52 of the piston forcing it towards the orifice 41 and the valve member further into the orifice against the action of the biasing spring 50. This movement of the valve member 44 restricts the flow rate of fluid through the system and slows the gear pump and thus the rate of descent of the descent apparatus to a rate below the higher rate that would have resulted from the greater weight of the person or load. With persons or loads of lesser weight than preset, the reverse effect will occur.

Since modifications within the spirit and scope of the invention may readily be effected by persons skilled within the art, it is to be understood that this invention is not limited to the particular embodiment described by way of example hereinabove.

1. A flow rate controller for a closed fluid circulating system, said controller including an orifice between upstream high pressure fluid and down stream low pressure fluid in said system, a valve member biased to partially close said orifice and cooperating with a piston member having one end exposed to low pressure fluid downstream of said orifice and an opposed end exposed to upstream high pressure fluid via a bypass passage, whereby, as upstream high fluid pressure increases said piston member acts to move said valve member further into said orifice to reduce the fluid flow through the system.

2. The flow rate controller according to claim 1, wherein the position of the valve member relative to the orifice is externally adjustable.

3. The flow rate controller according to either claim 1 or claim 2, wherein the bypass passage includes a first jet to control flow to the piston member and a bleed jet to control return to a low pressure reservoir.

4. The flow rate controller according to any one of the preceding claims, wherein the valve member is screw threadedly attached to the piston member whereby axial rotation of the valve member axially displaces the valve member relative to the piston member.

5. A closed fluid circulation system comprising a gear pump fed from a low pressure reservoir, the gear pump having a high pressure outlet coupled to the flow rate controller according to any one of claims 1 to 4; the low pressure fluid downstream of said orifice being returned to the reservoir.

6. A descent apparatus comprising a cable adapted to be wound onto a pulley rotatably mounted within a housing via an axle, whereby the relative rotation between the pulley and the axle is controlled by a closed fluid circulation system according to claim 5.

7. A descent apparatus for loads and/or persons, said apparatus including a cable or rope having one end adapted to fixed at an elevated location with the remainder of the cable or rope being wound around an inner pulley rotatably mounted within an outer housing via an axle shaft, wherein the outer housing is adapted to be attached directly to the load and/or person, and wherein the relative rotation between the inner pulley and the axle shaft is controlled by a closed circuit gear pump, the gears of which form transmission means between the inner pulley and the axle shaft, said closed circuit gear pump forming part of a hydraulic circuit containing a flow rate controller including an orifice between upstream high pressure fluid and downstream low pressure fluid in said gear pump, a valve member biased to partially close said orifice and cooperating with a piston member having one end exposed to low pressure fluid downstream of said orifice and an opposite end exposed to upstream high pressure fluid via a bypass passage, whereby, as upstream high pressure fluid increases said piston member acts to move said valve member further into said orifice to reduce the fluid flow through the pump.

8. The descent apparatus according to claim 7, wherein the inner pulley comprises a spool having radially extending annular flanges, the cable or rope being wound onto the spool between the flanges whereby the reduction in diameter of the spool from the wound to the fully unwound condition is approximately 40%.

9. The descent apparatus according to claim 8, wherein the spool defines an inner cavity which contains the closed circuit gear pump.

10. The descent apparatus as claimed in any one of claims 7 to 9, wherein the closed circuit gear pump includes a central sun gear which meshes with a plurality of diametrically opposed planet gears.

11. The descent apparatus according to claim 10, wherein the sun gear has a diameter that is twice the diameter of the planet gears.

12. The descent apparatus as claimed in either claim 10 or 11, wherein the sun and planet gears are rotably sandwiched between members which include a series of orifices and cavities and interconnecting channels through which hydraulic fluid for the hydraulic circuit is pumped through the closed circuit gear pump.

13. A descent apparatus as claimed in claim 12, wherein the orifice extends through one of the members which sandwich the sun and the planet gears.

14. A descent apparatus as claimed in any one of claims 7 to 13, wherein the position of the valve member relative to the orifice is adjustable from outside the apparatus to thereby control the rate of flow of hydraulic fluid through said closed circuit fluid pump and the speed of descent of the descent apparatus as the cable or rope unwinds from the inner pulley.
